(19) United States
(12) Patent Application Publication
(10) Pub. No.: US 2016/0020878 A1
(43) Pub. Date: Jan. 21, 2016

(54) TERMINAL DEVICE AND BASE STATION DEVICE

(71) Applicant: SHARP KABUSHIKI KAISHA, Osaka-shi, Osaka (JP)

(72) Inventors: Kazunari YOKOMAKURA, Osaka-shi, Osaka (JP); Hiroki TAKAHASHI, Osaka-shi, Osaka (JP); Osamu NAKAMURA, Osaka-shi, Osaka (JP); Jungo GOTO, Osaka-shi, Osaka (JP); Yasuhiro HAMAGUCHI, Osaka-shi, Osaka (JP)

(73) Assignee: SHARP KABUSHIKI KAISHA, Osaka-shi, Osaka (JP)

(21) Appl. No.: 14/773,155

(22) PCT Filed: Dec. 20, 2013
(86) PCT No.: PCT/JP2013/084365

§ 371 Date: Sep. 4, 2015

(30) Foreign Application Priority Data
Mar. 7, 2013 (JP) 2013-044839

(51) Int. Cl. H04L 5/00; H04W 72/04

(52) U.S. Cl. CPC H04L 5/0048; H04W 72/042; H04W 72/0453; H04W 88/08

(57) ABSTRACT

A terminal device that is capable of increasing the number of spatial multiplexes of a reference signal is provided. A terminal device according to the present invention is a terminal device that generates and transmits a reference signal. The terminal device includes a reference signal generation module that configures a repetition factor (RF) of the reference signal based on a signal which is notified by a base station, and generates the reference signal. Furthermore, the reference signal generation module uses at least one among multiple values that are included in the signal which is notified by the base station, only for configuration of the RF.

### TECHNICAL FIELD

The present invention relates to a terminal device and a base station device.

### BACKGROUND ART

In recent years, with the spread of smartphones and the increase in the number of users, there has been a need to further improve throughput across a system as a whole. In the Third Generation Partnership Project (3GPP), in order to increase a capacity per unit area, multiple pico base stations (a pico base station, in some cases, is also referred to as a low power node (LPN)) each having a small cell within a macro cell, are arranged, and a small cell enhancement (SCE) technology that offloads communication traffic onto the small cells has been studied for Release 12 of Long Term Evolution (LTE) that is a next generation mobile communication system (NPL 1).

On the other hand, even though the capacity is improved by offloading the communication traffic through installation of the small cells and thus acquiring a cell splitting gain, because an available frequency band is limited, there is a limit in a case where only the cell splitting gain, which increases in proportion to the number of small cells, is aimed. Because of this, not only the cell splitting through the installation of the small cell, but also Multi-user Multiple-Input Multiple-output (MIMO), non-orthogonality access, and the like that actively utilize a spatial resource have been studied (NPL 2 and NPL 3) as a means of improving frequency efficiency per cell.

### CITATION LIST

### Non Patent Literature

NPL 1: 3GPP, RP-122032, “New Study Item Proposal for Small Cell Enhancements for E-UTRA and E-UTRAN—Physical-layer Aspects”, RAN plenary #58, December, 2012.

NPL 2: D. Nishikawa, et al., “Investigation on resource assignment and power control schemes for uplink MU-MIMO in multi-cell environments for LTE/LTE-advanced”, IEEE APCC 2010, November, 2010.

NPL 3: P. Wang, et al., “Comparison of orthogonal and non-orthogonal approaches to future wireless cellular systems”. IEEE Vhecular Technology Magazine, September, 2006.

### SUMMARY OF INVENTION

### Technical Problem

In a case where MU-MIMO scheme or the non-orthogonality access scheme is applied to an uplink (communication line from a terminal device to a base station device), it is desirable that in order to estimate performance of a channel from a user (User Equipment (UE)), which is spatially multiplexed in the base station device, a reference signal is orthogonalized.

In LTE system, it is possible to demultiplex multiple reference signals by performing multiplication by a code that is referred to as a cyclic shift and that can be used for orthogonalization in a frequency domain, but this causes a problem that if a bandwidth and a frequency position of the UE that perform spatial multiplexing are not the same, the orthogonalization is not possible.

Additionally, the multiplication by a code that can be used for orthogonalization in a time domain and that is referred to as orthogonal cover code (OCC) with a length of 2 is performed, and thus the reference signals can be orthogonalized regardless of the bandwidth and the frequency position, but this causes a problem that the orthogonalization can be performed for only up to 2 multiplexes.

### Solution to Problem

In order to solve the problems described above, configuration of a terminal device and a base station device according to the present invention are as follows.

(1) According to the present invention, there is provided a terminal device that generates and transmits a reference signal, the terminal device including: a reference signal generation module that configures a repetition factor (RF) of the reference signal based on a signal which is notified by a base station, and generates the reference signal.

(2) According to the present invention, in the terminal device, the reference signal generation module uses at least one among multiple values that are included in the signal which is notified by the base station, only for configuration of the RF.

(3) According to the present invention, in the terminal device, the reference signal generation module uses at least one among multiple values that are included in the signal which is notified by the base station, for configuration of the RF and a parameter other than the RF.

(4) According to the present invention, in the terminal device, the reference signal generation module applies the RF only in a case where a specific control signal is detected.

(5) According to the present invention, in the terminal device, the reference signal generation module configures the RF, being associated with a value that designates a cyclic shift or an orthogonal cover code.

(6) According to the present invention, there is provided a base station device that notifies a parameter for a reference signal that is used by a terminal device, in which the base station device transmits a parameter relating to an RF to the terminal device based on a desired RF.

(7) According to the present invention, in the base station device, the parameter relating to the RF is transmitted to the terminal device, being associated with a value that designates a cyclic shift or an orthogonal cover code.

(8) According to the present invention, in the base station device, the parameter relating to the RF is transmitted to the terminal device, using control information for downlink, along with information that includes frequency allocation information for uplink.

(9) According to the present invention, in the base station device, the parameter relating to the RF is configured based on the number of necessary orthogonal reference signals.

### Advantageous Effects of Invention

According to the present invention, the number of reference signals that are orthogonalized with high efficiency can be increased.

### BRIEF DESCRIPTION OF DRAWINGS

FIG. 1 is a configuration of a subframe for LTE uplink.

FIG. 2 is a schematic diagram of a reference signal that is based on IFDM.

FIG. 3 is a schematic diagram illustrating a spectrum of a frequency domain in a case where the reference signal that is based on the IFDM is multiplexed in multiple terminal devices.

FIG. 4 is a schematic diagram illustrating a configuration of a terminal device according to a first embodiment.

FIG. 5 is a diagram illustrating a bit sequence and RF information.

FIG. 6 is a schematic diagram illustrating the configuration of the terminal device according to the first embodiment.

FIG. 7 is a diagram illustrating the bit sequence at a CSI field, a CSI value and the RF information that is associated with the CSI value.

FIG. 8 is a schematic diagram illustrating the configuration of the terminal device according to the first embodiment.

FIG. 9 is a schematic diagram of a system to which non-orthogonality access is applied.

### DESCRIPTION OF EMBODIMENTS

### First Embodiment

A first embodiment of the present invention is described below. According to the following embodiments, on the assumption of an uplink, descriptions are provided using a subframe configuration for LTE, but the nature of the invention is the same, and this does not impose any limitation.

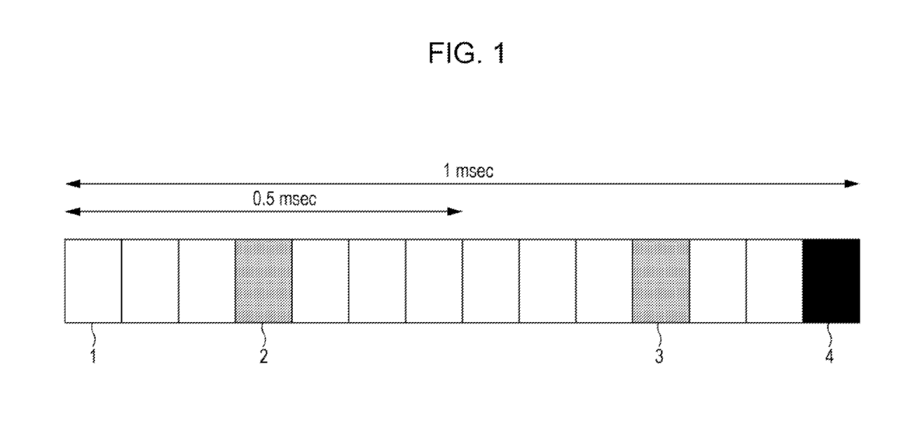

FIG. 1 illustrates the subframe configuration for LTE uplink. The LTE uplink is configured from Discrete Frequency Transform Spread Orthogonal Frequency Division Multiplexing (DFT-S-OFDM) symbols that are time-multiplexed 14 symbols. One subframe is 1 millisecond. First-half 7 symbols and second-half 7 symbols are referred to as one slot. The one slot is 0.5 milliseconds. 1 that is indicated by white is a DFT-S-OFDM symbol for data communication, and 2 and 3 that are symbols in the middle of each slot, that is, a fourth symbol and an eleventh symbol are demodulation reference signals (DMRSs). These symbols are known signals that are transmitted in accordance with a rule that is determined in advance by specifications. A symbol that is indicated by 4 is a symbol with which transmission of a sound reference signal (SRS) is possible. If a subframe is an SRS subframe, the SRS is transmitted, and if not, a data symbol is transmitted.

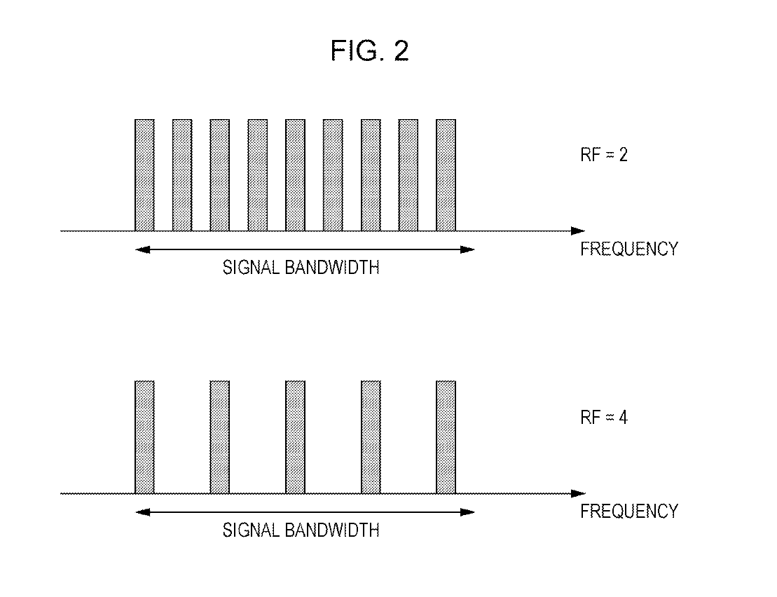

FIG. 2 illustrates a concept of the present embodiment. FIG. 2 illustrates an example of a case where the DMRS is transmitted in a frequency domain. In the drawing, a reference signal is illustrated that is based on interleaved frequency division multiplexing (IFDM). FIG. 2 illustrates a frequency signal of the reference signal in a case where a repetition factor (RF) is set to be 2 or 4. A signal is mapped only to a gray resource element (a subcarrier). That is, in a case where RF=2, a period of a resource element to which a signal is mapped is 2, and a different reference signal can be orthogonally multiplexed onto a resource element between the resource elements to which the signal is mapped. In the same manner, in a case where RF=4, a period of the resource element to which the signal is mapped is 4, and a different reference signal can be orthogonality multiplexed onto the remaining resource elements.

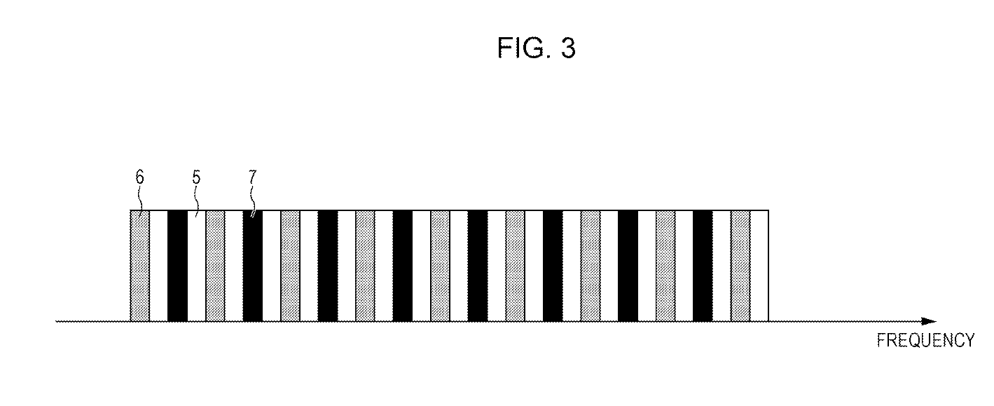

FIG. 3 illustrates an example of an orthogonal multiplexing of the reference signal in a case where the number of items of UE that transmit the reference signal with RF=2 is set to be 1 and the number of items of UE that transmit the reference signal with RF=4 is set to be 2. A resource element 5 that is indicated by white is a reference signal of UE with RF=2. Elements 6 and 7 that are indicated by gray and black, respectively, are reference signals of UE with RF=4. A resource element that is indicated by a different color means a signal to which a different item of UE is mapped. In this manner, channel estimation can be performed in a communication device that is a reception device, even in a case where with multi-user MIMO and the like, multiple items of UE transmit data signals over the same frequency band.

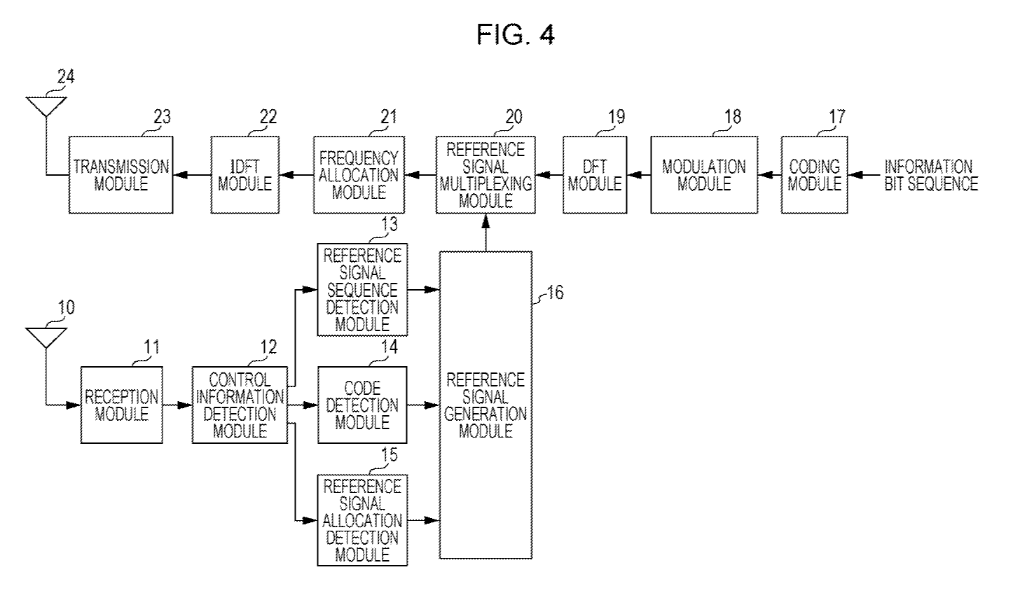

According to the present invention, a construction for adaptively realizing this is disclosed. FIG. 4 illustrates a configuration of a terminal device. The terminal device is configured from a receive antenna 10, a reception module 11, a control information detection module 12, a reference signal sequence detection module 13,a code detection module 14, a reference signal assignment detection module 15, a reference signal generation module 16, a coding module 17, a modulation module 18, a DFT module 19, a reference signal multiplexing module 20, a frequency allocation module 21, an IDFT module 22, a transmission module 23, and a transmit antenna 24.

In the receive antenna 10, a control signal that is transmitted from a base station device is received.

The reception module 11 converts the received control signal into a baseband digital signal by down-conversion, digital-to-analog (D/A) conversion, and the like.

In the control information detection module 12, control information is detected from the baseband digital signal.

In the reference signal sequence detection module 13, information (information for determining amplitude of the reference signal) relating to a reference signal sequence is detected from the detected signal.

In the code detection module 14, a code (for example, a cyclic shift (CS) sequence or an orthogonal cover code (OCC)) by which the reference signal sequence is multiplied is detected from the signal that is detected in the control information detection module 12.

In the reference signal assignment detection module 15, an RF value that is illustrated in FIG. 3, and a frequency position (information that is also referred to as a comb index and indicates which position a signal is mapped to) to which the signal is mapped are detected.

In the reference signal generation module 16, based on the reference signal sequence detection module 13, the code detection module 14, and the reference signal assignment detection module 15, the reference signal is generated and is input into the reference signal multiplexing module 20.

In the coding module 17, an information bit sequence goes through error correcting coding. Moreover, in the present application, a signal that is obtained from this information sequence is referred to as a data signal.

In the modulation module 18, a code bit sequence that goes through the error correcting coding in the coding module 17 is modulated onto a Quaternary Phase Shift Keying (QPSK) signal, 16 Quadrature Amplitude Modulation (QAM) signal, or the like.

In the DFT module 19, a modulation symbol that is obtained in the modulation module 18 is converted by Discrete Fourier Transform (DFT) into a frequency signal.

In the reference signal multiplexing module 20, the frequency signal that is obtained in the DFT module 19 and the reference signal that is generated in the reference signal generation module 16 are multiplexed and results of the multiplexing are output to the frequency allocation module 21. At this time, for example, as illustrated in FIG. 1, the reference signal and the data signal are multiplexed at different times.

In the frequency allocation module 21, the signal that is output from the reference signal multiplexing module 20 is mapped to a transfer band that is designated for a base station device.

In the IDFT module 22, the signal that is mapped in the frequency allocation module 21 is converted by Inverse DFT (IDFT) into a time signal.

In the transmission module 23, cyclic prefix (CP) addition, digital-to-analog (D/A) conversion, and up-conversion are performed on the time signal that is obtained in the IDFT module 22, and thus the resulting signal is converted into a transmit signal.

In the transmit antenna 24, the transmit signal that is obtained in the transmission module 23 is transmitted.

In this manner, according to the present invention, it is disclosed that pieces of information relating to the reference signal, particularly, an RF of the reference signal and the frequency position (the comb index) (these are collectively defined as RF information) is received from the control information that is received by a terminal device, and the pieces of information are applied to the reference signal.

Next, how the information relating to the reference signal is notified from the control information is described. Moreover, because generation of the control information is performed by a base station device, a configuration of the control information will be described below.

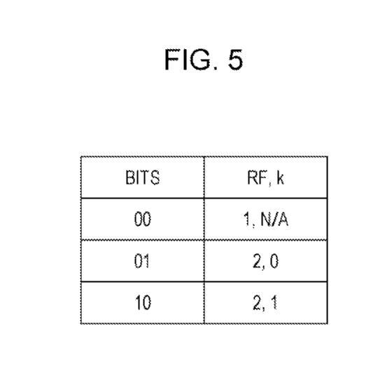

FIG. 5 illustrates one example of the information relating to the reference signal. FIG. 5 illustrates the information relating to the reference signal that is transmitted on Physical Downlink Control Channel (PDCCH) that is referred to as downlink control information (DCI). The information relating to the reference signal indicates an RF and a comb index k. For example, “1, N/A” means that a reference signal with RF=1 is configured, and a reference signal is successively assigned within a transfer band. On the other hand, “2, 0” means that a reference signal with RF=2 is transmitted with a comb index 0. Specifically, in a reference signal with RF=2, resource elements are alternately used, and in this case, the orthogonal multiplexing is possible with an even-numbered resource element and an odd-numbered resource element. The comb index 0 means an even-numbered resource element group, and the comb index 1 means an odd-numbered resource element group. In the same manner, in a case where RF=4, because 0 to 3, that is, 4 types of orthogonal resources, are selected, this expansion is also included in the present invention.

Next, UE that is notified of the control signal is described. Most of all, in a case where multiple items of UE are spatially multiplexed, the reference signal that is based on the IFDM is valid as a method of increasing the number of orthogonal resources. For this reason, it is considered that fields in FIG. 5 for specific DCI, not for all pieces of DCI, are configured. For example, in a case of a transfer mode 1 that is already employed in LTE, a control signal that is referred to as a DCI format 0 is transmitted to a terminal device. In this case, decoding processing as in the related art is applied in each item of UE without generating the reference signal that is based on the IFDM. On the other hand, in a case of a transfer mode 2 that supports MIMO, a DCI format 4 is used in the related art, and a bit field that is based on a table in FIG. 5 is added to the DCI format 4. Moreover, an example is illustrated in which the bit field is added only to the DCI corresponding to the transfer mode that corresponds to the MIMO, but if the bit field is added only to specific DCI or to control information, this is included in the present invention. Of course, in a case where the bit field is added to all the pieces of DCI, this is also included in the present invention.

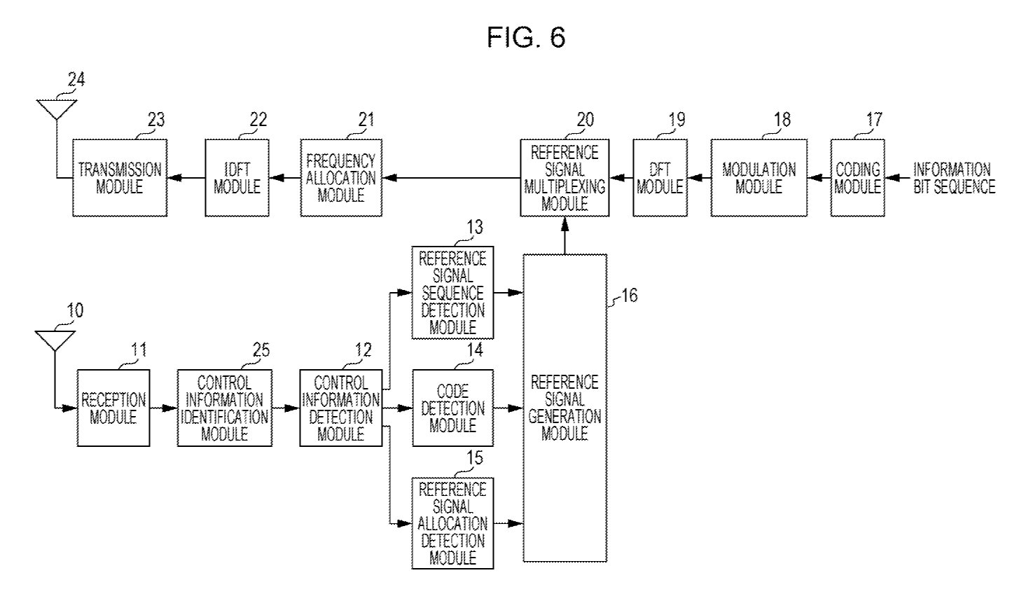

FIG. 6 illustrates a configuration example of a terminal device. What distinguishes FIG. 6 from FIG. 4 is that a control information identification module 25 is newly added. The control information identification module 25 identifies a type of control information that is notified by a base station device, and identifies whether or not a field for generating the reference signal that is based on the IFDM in FIG. 5 is present. Thereafter, generation of the reference signal is performed in a module that comes after the control information detection module 12. In this manner, such processing is applied to the DCI corresponding to the transfer mode in which a large number of reference signals that have to be orthogonalized are present, and thus even if the number of items of UE that are to be space-multiplexed at some time is increased, an orthogonal resource for the reference signal can be secured, thereby improving transmission performance of the system.

### Second Embodiment

According to the first embodiment, information to which the reference signal that is based on the IFDM is applied is notified using bits, but a method of making an implicit notification according to the present embodiment is described.

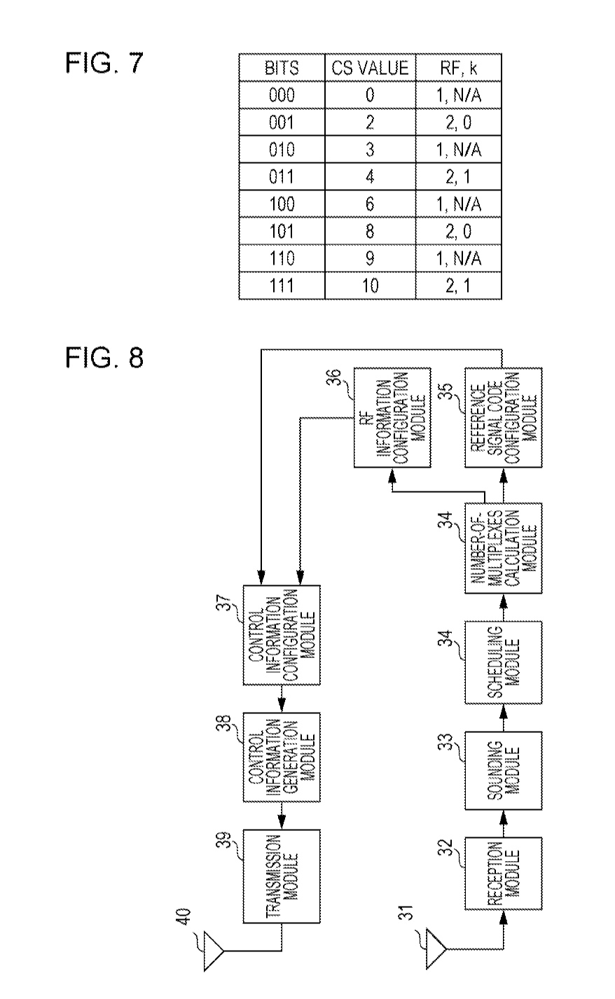

FIG. 7 illustrated one example of information for generating the reference signal. FIG. 7 illustrates an example that is associated with a CS value field which is included in the DCI that is already employed in LTE. A CS value is information on an orthogonal code that is referred to as a cyclic shift that causes given phase rotation between resource elements. The greater the value, the more an amount of phase rotation between the resource elements is increased. As illustrated in FIG. 7, in a case where “RF, k” is associated with the CS value, and for example, three bits representing “000” are notified, this means that the reference signal with RF=1 to which CS value=0 is applied is generated. In a case where three bits representing “011” are notified, this means that a reference signal that is based on RF=1 with CS value=4 and on IFDM with comb index=1 is generated. In this manner, when the RF value is implicitly notified by being associated with the CS value field, the reference signal can be generated without increasing the number of information bits.

A configuration example of the terminal device for reduction of the present invention to practice is the same as that in FIG. 4. When a control signal is detected, information of the reference signal that is based on the IFDM is interpreted as well using the CS value field.

Additionally, as described according to the first embodiment, a rule that such interpretation should be provided only to a specific DCI format may be defined, and the interpretation in FIG. 7 may be provided only to a CS value field for a specific control signal. In this case, a configuration of a terminal device is a configuration as illustrated in FIG. 6. A type of control information is identified in the control information identification module 25, and RF information is implicitly interpreted.

FIG. 8 illustrates a configuration of a base station device for realizing the first and second embodiments. The base station device is configured from a receive antenna 31, a reception module 32, a sounding module 33, a scheduling module 34, the number-of-multiplexes calculation module 34, a reference signal code configuration module 35, an RF information configuration module 36, a control information configuration module 37, a control information generation module 38, a transmission module 39, and a transmit antenna 40.

In the receive antenna 31, a sounding reference signal that is transmitted from a terminal device is received.

In the reception module 32, the down-conversion, the A/D conversion, and the like are performed on the received sounding reference signal, and the resulting signal is converted into a baseband signal.

In the sounding module 33, channel frequency characteristics are calculated from the baseband signal that is obtained in the reception module 32.

In the number-of-multiplexes calculation module 34, the number of terminals that use at least one portion of the same transfer band is calculated from a result of scheduling.

In the reference signal code configuration module 35, information relating to a code of the orthogonal code, such as the CS value, is configured.

In the RF information configuration module 36, a parameter for generating the reference signal that is based on the IFDM is configured.

In the control information configuration module 37, control information is configured based on pieces of information necessary for the generation of the reference signal, which are obtained from the reference signal code configuration module 35 and the RF information configuration module 36.

In the control information generation module 38, the control information is generated based on a type (for example, a DCI format) of configured control information.

In the transmission module 39, a transmit signal is generated by the D/A conversion and the up-conversion from the generated control information, and the resulting transmit signal is transmitted from the transmit antenna 40.

Moreover, a configuration in FIG. 8 results from calculating the number of multiplexes and thus performing the configuring according to the number of multiplexes, but the number-of-multiplexes calculation module 34 is not indispensable. A case where the configuring is performed without depending on determination by the number-of-multiplexes calculation module 34 is included in the present invention.

### Third Embodiment

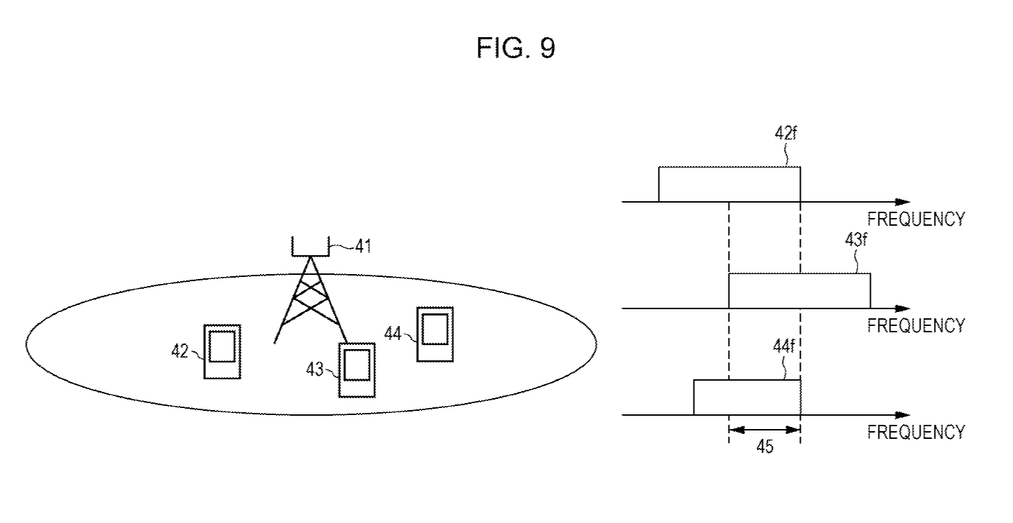

A third embodiment illustrates an example of application to non-orthogonality access. FIG. 9 illustrates a concept of the non-orthogonality access. FIG. 9 illustrates an example in which three terminal devices 42, 43, and 44 communicate with a base station device 41 with two receive antennas using the same frequency. Furthermore, 42f, 43f, and 44f indicate transfer bands of the terminal devices 42, 43, and 44, respectively. As illustrated in FIG. 9, data is multiplexed in a non-orthogonal manner in a frequency band that is indicated by 45. In this case, detection of a data signal is realized by a non-linear receiver such as turbo equalization or a serial interference canceller.

However, in order to apply these, a channel estimation between each terminal device and the base station device 41 is necessary, and it is desirable that the reference signal (the DMRS) is orthogonalized. In such a case, a method that is referred to as configuring an RF value based on the number of orthogonal multiplexes is also applicable. In this manner, the method that is referred to as configuring the RF value based on the number of multiplexes is also included in the present invention.

A program running on the base station device and the terminal device according to the present invention is a program (a program for causing a computer to perform functions) that controls a CPU and the like in such a manner as to realize the functions according to the embodiments of the present invention. Then, pieces of information that are handled in these devices are temporarily stored in a RAM while being processed. Thereafter, the pieces of information are stored in various ROMs or HDDs, and whenever necessary, are read by the CPU to be modified or written. As a recording medium on which to store the program, among a semiconductor medium (for example, a ROM, a nonvolatile memory card, and the like), an optical storage medium (for example, a DVD, an MO, an MD, a CD, a BD, and the like), a magnetic storage medium (for example, a magnetic tape, a flexible disk, and the like), and the like, any one may be possible. Furthermore, in some cases, the functions according to the embodiments described above are realized by running the loaded program, and in addition, the functions according to the present invention are realized by performing processing in conjunction with an operating system or other application programs, based on an instruction from the program.

Furthermore, in a case where programs are distributed on the market, the programs, each of which is stored on a portable recording medium, can be distributed, or the program can be transmitted to a server computer that is connected through a network such as the Internet. In this case, a storage device of the server computer is also included in the present disclosure. Furthermore, some of or all of the portions of the terminal device and the base station device according to the embodiments described above may be realized as an LSI that is a typical integrated circuit. Each functional block of a reception device may be individually built into a chip, and some or all functional blocks may be integrated into a chip. In a case where each functional block is integrated into a circuit, an integrated circuit control module is added that controls these functional blocks.

Furthermore, a technique of the integrated circuit is not limited to an LSI, and an integrated circuit for the functional block may be realized with a dedicated circuit or a general-purpose processor. Furthermore, if with advances in semiconductor technology, a circuit integration technology with which an LSI is replaced appears, it is also possible to use an integrated circuit to which such a technology is applied.

Moreover, the invention in the present application is not limited to the embodiments described above. Furthermore, application of the terminal device according to the invention in the present application is not limited to the mobile station device. It goes without saying that the terminal device can be applied to a stationary-type electronic apparatus that is installed indoors or outdoors, or a non-movable-type electronic apparatus, for example, an AV apparatus, a kitchen apparatus, a cleaning or washing machine, an air-conditioning apparatus, office equipment, a vending machine, and other household apparatuses.

The embodiments of the present invention are described in detail above referring to the drawings, but the specific configuration is not limited to the embodiments. A design and the like within a scope not departing from the gist of the present invention fall within the scope of the claims.

### INDUSTRIAL APPLICABILITY

The present invention is suitably used for a communication device and a communication system.

### REFERENCE SIGNS LIST

1 SUBFRAME CONFIGURATION FOR LTE

2 DEMODULATION REFERENCE SIGNAL

3 DEMODULATION REFERENCE SIGNAL

4 SYMBOL WITH WHICH TRANSMISSION OF SOUNDING REFERENCE SIGNAL IS POSSIBLE

5 REFERENCE SIGNAL OF UE WITH RF=2

6 REFERENCE SIGNAL OF UE WITH RF=4

7 REFERENCE SIGNAL OF UE WITH RF=4

10 RECEIVE ANTENNA

11 RECEPTION MODULE

12 CONTROL INFORMATION DETECTION MODULE

13 REFERENCE SIGNAL SEQUENCE DETECTION MODULE

14 CODE DETECTION MODULE

15 REFERENCE SIGNAL ASSIGNMENT DETECTION MODULE

16 REFERENCE SIGNAL GENERATION MODULE

17 CODING MODULE

18 MODULATION MODULE

19 DFT MODULE

20 REFERENCE SIGNAL MULTIPLEXING MODULE

21 FREQUENCY ALLOCATION MODULE

22 IDFT MODULE

23 TRANSMISSION MODULE

24 TRANSMIT ANTENNA

25 CONTROL INFORMATION IDENTIFICATION MODULE

31 RECEIVE ANTENNA

32 RECEPTION MODULE

33 SOUNDING MODULE

34 SCHEDULING MODULE

35 REFERENCE SIGNAL CODE CONFIGURATION MODULE

36 RF INFORMATION CONFIGURATION MODULE

37 CONTROL INFORMATION CONFIGURATION MODULE

38 CONTROL INFORMATION GENERATION MODULE

39 TRANSMISSION MODULE

40 TRANSMIT ANTENNA

41 BASE STATION DEVICE

42 TERMINAL DEVICE

42-f TRANSFER BAND OF TERMINAL DEVICE 42

43 TERMINAL DEVICE

43-f TRANSFER BAND OF TERMINAL DEVICE 43

44 TERMINAL DEVICE

44-f TRANSFER BAND OF TERMINAL DEVICE 44

45 FREQUENCY BAND IN WHICH MULTIPLEXING IS PERFORMED IN

A NON-ORTHOGONAL MANNER

1. A terminal device that generates and transmits a reference signal, the terminal device comprising:
a reference signal generation module that configures a repetition factor (RF) of the reference signal based on a signal which is notified by a base station, and generates the reference signal.

2. The terminal device according to claim 1,
wherein the reference signal generation module uses at least one among multiple values that are included in the signal which is notified by the base station, only for configuration of the RF.

3. The terminal device according to claim 1,
wherein the reference signal generation module uses at least one among multiple values that are included in the signal which is notified by the base station, for configuration of the RF and a parameter other than the RF.

4. The terminal device according to claim 1,
wherein the reference signal generation module applies the RF only in a case where a specific control signal is detected.

5. The terminal device according to claim 3,
wherein the reference signal generation module configures the RF, being associated with a value that designates a cyclic shift or an orthogonal cover code.

6. A base station device that notifies a parameter for a reference signal that is used by a terminal device,
wherein the base station device transmits a parameter relating to an RF to the terminal device based on a desired RF.

7. The base station device according to claim 6,
wherein the parameter relating to the RF is transmitted to the terminal device, being associated with a value that designates a cyclic shift or an orthogonal cover code.

8. The base station device according to claim 6,
wherein the parameter relating to the RF is transmitted to the terminal device, using control information for downlink, along with information that includes frequency allocation information for uplink.

9. The base station device according to claim 6,
wherein the parameter relating to the RF is configured based on the number of necessary orthogonal reference signals.

10. The base station device according to claim 7,
wherein the parameter relating to the RF is transmitted to the terminal device, using control information for downlink, along with information that includes frequency allocation information for uplink.
